(19) United States
(12) Patent Application Publication
(10) Pub. No.: US 2011/0110198 A1
(43) Pub. Date: May 12, 2011

(54) Game Timer

(75) Inventors: Bernard Johan Bulsink, Enschede (NL); Albert Vasse, Enschede (NL); Sander W. Nieuwboer, Enschede (NL)

(73) Assignee: DGT HOLDING B.V., Enschede (NL)

(21) Appl. No.: 12/942,330

(22) Filed: Nov. 9, 2010

(30) Foreign Application Priority Data
Nov. 11, 2009 (EP) 09175713.8
Nov. 11, 2009 (EP) 091757513.8

(51) Int. Cl. G04F 3/00

(52) U.S. Cl. 368/96

(57) ABSTRACT

The invention relates to a device for keeping time for at least two players of a game. The device includes: a housing with at least two surfaces; an orientation sensor arranged in the housing for sensing the orientation of the housing; a display arranged at each of the at least two surfaces of the housing; a timer corresponding to each surface; and a controller for registering the orientation from the orientation sensor and controlling the display and the timer corresponding to an active surface, which depends on the orientation of the housing.

### BACKGROUND OF THE INVENTION

1) Field of the Invention

The invention relates to a device for keeping time for at least two players of a game.

2) Prior Art

When playing games, like board games, it often desired to keep track of the time a player uses. This ensures that each player is given a fair amount of time to think about the next move and also ensures that a game is completed within a reasonable amount of time.

The time could be limited per move of a player or could be limited for the game per player. Furthermore, the time limit per move could be set equal for each move, or could be raised when the player did not use all the time for the previous game.

For keeping time it is known to use an hourglass. An hourglass is not flexible in the time limit. Each hourglass has a specific time, like for example one minute, in which the sand runs from the top to the bottom. If a player makes his next move in for example 25 seconds, one has to wait at least 25 seconds before the hourglass can be used for the next player. Furthermore an hourglass cannot keep track of the amount of time a player uses for all of the moves during a game.

For playing chess, special chess clocks are known in the prior art. These chess clocks are limited to only two players. Instead of using an hourglass one can also use a stopwatch or other timer device, but these devices are not user friendly when playing a game with a few players.

### SUMMARY OF THE INVENTION

Accordingly, it is an object of the invention to provide a device for keeping time, which is more user friendly and provides more freedom in tracking time during playing a game.

This object is achieved with a device according to the invention, which device comprises:
a housing with at least two surfaces;
an orientation sensor arranged in the housing for sensing the orientation of the housing;
a display arranged at each of the at least two surfaces of the housing;
a timer corresponding to each surface; and
a controller for registering the orientation from the orientation sensor and controlling the display and the timer corresponding to an active surface, which depends on the orientation of the housing.

With the device according to the invention it possible to start and stop a timer dedicated to a player, simply by turning the housing to a surface, which is assigned to a player.

When starting a game, each player selects a surface of the device and the respective timers are reset. When the device is positioned with a first surface facing upwards, the respective timer starts to count and the player, which selected this first surface, may make the first move in the game. The status of the timer is shown on the display of the first surface. When the first player has made the move, the device is turned, such that a second surface is facing upwards. The orientation sensor senses this change of orientation. The controller accordingly stops the timer of the first surface and starts the timer of the second surface. In this way, the time each player uses can simply be tracked by positioning the device corresponding to the player which is about to make a move.

In a preferred embodiment of the device the orientation sensor comprises an accelerometer. An accelerometer can accurately determine the orientation of the device by measuring the earth gravity force. In particular when the device comprises a number of surfaces, for example when the housing is a tetrahedron with four surfaces, a cube with six surfaces or an octahedron with eight surfaces, the accelerometer can quickly determine the orientation of the housing.

In another embodiment of the device according to the invention the orientation sensor comprises a switch arranged on each of the at least two surfaces, which switch is activated by placing the device on the respective surface.

The orientation can also be determined by a switch which is activated on the opposite surface from the surface, which is facing upwards. This switch could be a mechanical switch or a light sensor.

In another preferred embodiment of the device according to the invention each of the at least two surfaces comprises a pause button for pausing the timer of the respective surface.

During game playing, it is sometimes desired to be able to pause the game, for example to get refreshments. By pushing the pause button on the active upward facing surface, the active timer is paused, such that the game can be paused.

In yet another preferred embodiment of the device according to the invention one surface of the at least two surfaces comprises at least one control button for programming the timers of the at least two surfaces. With the control button it is possible to set a specific game playing mode of the device. This game playing mode can be preprogrammed in the controller or the user can set specific time limits for the each timer of each surface and the way the timers count. In this way it is possible to program the device and the respective timers depending on the game type and the desired time keeping for the game.

In still another preferred embodiment of the device each of the at least two surfaces is provided with a distinct color. The distinct color helps a player to find his or her dedicated surface and activate the respective timer. If the game played uses pawns with distinct colors, these colors could be linked with the distinct colors of the surface.

In another embodiment the device is provided with different marks to identify each surface.

It is furthermore preferred that the device according to the invention comprises sound generating means for generating a signaling sound. This signal can for example be given when the timer is active or when the timer reaches the preset limit.

In a further preferred embodiment of the device according to the invention each display is arranged on a printed circuit board and comprises the housing at each surface an opening behind which a respective display is arranged. The printed circuit board provide a solid base to arrange the display to, while the housing can be shaped to a more aesthetic shape.

Preferably the printed circuit boards are electrically interconnected to exchange data. In this way one of the boards can be provided with the electronic components for the controller. The controller can then control all displays through exchange of data between the several printed circuit boards.

The housing comprises preferably two shells portions. These shell portions can easily be arranged around the printed circuit boards, providing a solid housing for the device according to the invention.

### BRIEF DESCRIPTION OF THE DRAWINGS

These and other features of the invention are elucidated in conjunction with the accompanying drawings.

FIG. 1 shows a perspective view of an embodiment of the device according to the invention;

FIG. 2 shows the device of FIG. 1 without the housing;

FIG. 3 shows the device of FIG. 1 partially in exploded view;

FIG. 4 shows an electronic schematic of the device of FIG. 1; and

FIG. 5 shows the device of FIG. 1 in a paused state.

### DETAILED DESCRIPTION OF THE INVENTION

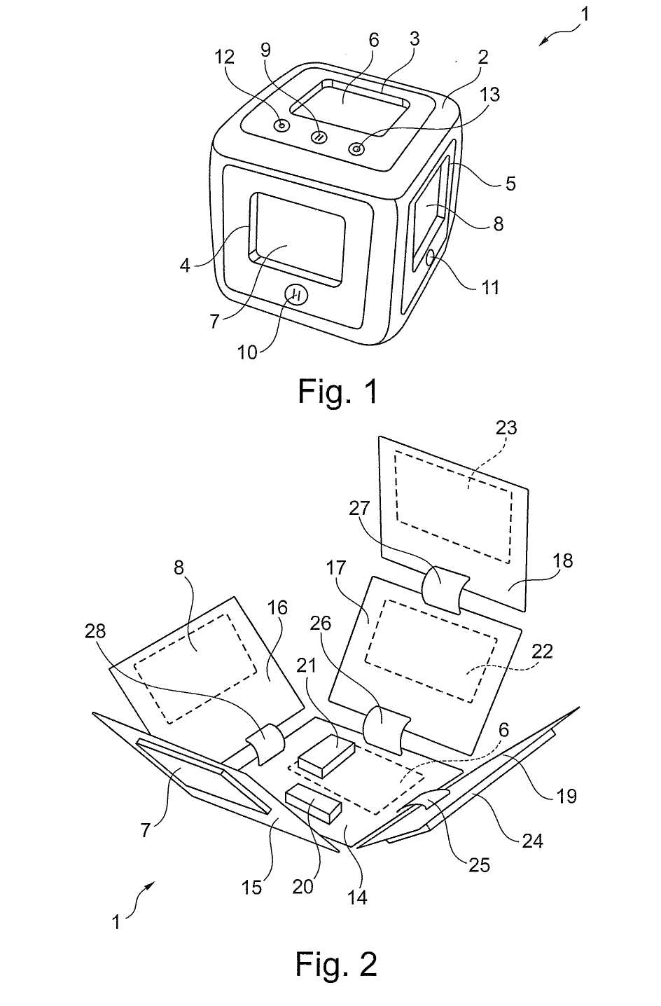

FIG. 1 shows an embodiment 1 of the device according to the invention. The device 1 has a cube shaped housing 2. Each surface of the device 1 has an opening 3, 4, 5 respectively, behind which a display 6, 7, 8 respectively is arranged. This display 6, 7, 8 could be a LCD or OLED display or any other suitable display.

Each surface of the device 1 is provided with a pause button 9, 10, 11 to pause the respective timer of the respective display 6, 7, 8. One surface has additional control buttons 12, 13 for setting the timers of each display 6, 7, 8.

In FIG. 2 the device 1 is shown without the housing 2. For each surface of the cube shaped housing 2, a printed circuit board 14-19 is arranged. The printed circuit board 14 is in this embodiment the main circuit board on which an accelerometer 20 is arranged an a microprocessor 21, which comprises at least the six different timers for each of the displays 6, 7, 8, 22, 23, 24. The data for controlling the displays 6, 7, 8, 22, 23, 24 is sent by the microprocessor 21 via the electric cables 25, 26, 27, 28.

When assembling the device 1, the printed circuit boards 14-19 are folded to a cube, after which the housing 2 is arranged around the circuit boards 14-19.

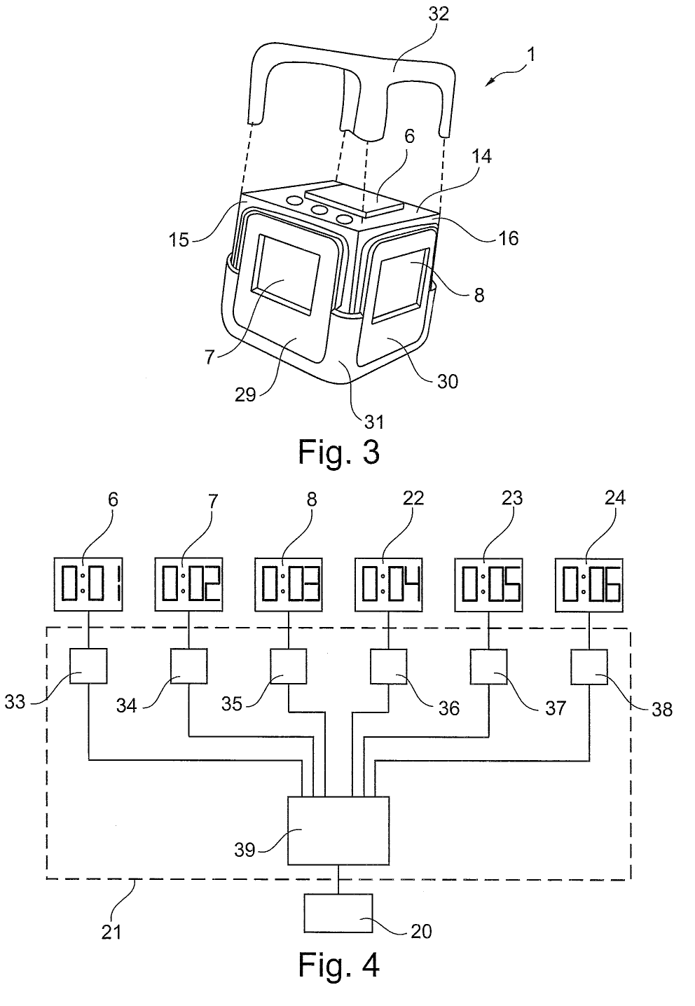

In FIG. 3 the device 1 is shown in partially exploded view. The housing 2 is composed out of six front panels 29, 30, which are arranged in front of each printed circuit board 14-19. These panels 29, 30 are kept together by to shell parts 31, 32.

The front panels 29, 30 could be provided with distinct colors, so a player can quickly find the assigned surface with respective timer and display.

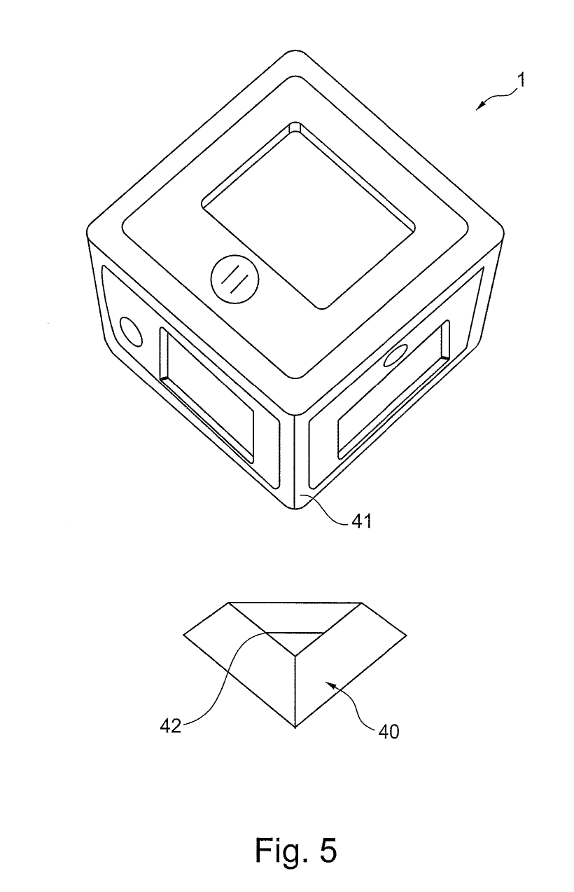

In FIG. 4 the electronic schematic of the device 1 is shown. Each display 6, 7, 8, 22, 23, 24 comprises a respective timer 33-38. Each timer 33-38 is controlled by a controller 39. The controller 39 and timers 33-38 are preferably integrated in the microprocessor 21.

Furthermore the device 1 comprises an orientation sensor 20, which is connected to the controller 39. Depending on the sensed orientation, the controller 39 activates one of the timers 33-38 with the respective displays 6, 7, 8, 22, 23, 24.

In FIG. 5 the device 1 is positioned with a corner pointing downwards. In this position, the device 1 is not placed on either one of the surfaces, such that none of the timers will run, bringing the device 1 effectively in a paused state.

To keep the device 1 in this paused state, the device 1 can be placed on a support 40. This support 40 has a triangular top opening 42, in which the corner 41 of the device is put. The edges of the triangular opening 42 will support the device 1 and keep it in the paused state.

1. A device for keeping time for at least two players of a game, which device comprises:
a housing with at least two surfaces;
an orientation sensor arranged in the housing for sensing the orientation of the housing;
a display arranged at each of the at least two surfaces of the housing;
a timer corresponding to each surface; and
a controller for registering the orientation from the orientation sensor and controlling the display and the timer corresponding to an active surface, which depends on the orientation of the housing.

2. The device according to claim 1, wherein the orientation sensor comprises an accelerometer.

3. The device according to claim 1, wherein the orientation sensor comprises a switch arranged on each of the at least two surfaces, which switch is activated by placing the device on the respective surface.

4. The device according to claim 3, wherein the switch is a light sensor.

5. The device according to claim 1, wherein each of the at least two surfaces comprises a pause button for pausing the timer of the respective surface.

6. The device according to claim 1, wherein one surface of the at least two surfaces comprises at least one control button for programming the timers of the at least two surfaces.

7. The device according to claim 1, wherein each of the at least two surfaces is provided with a distinct color.

8. The device according to claim 1, comprising sound generating means for generating a signaling sound.

9. The device according to claim 1, wherein each display is arranged on a printed circuit board and wherein the housing comprises at each surface an opening behind which a respective display is arranged.

10. The device according to claim 9, wherein the printed circuit boards are electrically interconnected to exchange data.

11. The device according to claim 1, wherein the housing comprises two shells portions.
